(19) United States
(12) Patent Application Publication
(10) Pub. No.: US 2021/0377255 A1
(43) Pub. Date: Dec. 2, 2021

(54) SYSTEMS, METHODS, AND APPARATUSES FOR NETWORK CREDENTIAL MANAGEMENT

(71) Applicant: COMCAST CABLE COMMUNICATIONS, LLC, Philadelphia, PA (US)

(72) Inventor: Weston Schmidt, San Jose, CA (US)

(21) Appl. No.: 16/885,050

(22) Filed: May 27, 2020

(51) Int. Cl. H04L 29/06; H04L 9/14; H04L 9/30; H04W 12/06

(52) U.S. Cl. CPC H04L 63/0823; H04L 63/0428; H04W 12/06; H04L 9/30; H04L 9/14

(57) ABSTRACT

Methods, systems, and apparatuses for network credential management are described. Computing devices may communicate with a network device via a network. To communicate with the network, the computing devices may be required to provide network credentials to the network device. The network device may receive and/or determine an update to the network credentials. The network device may securely send the updated network credentials to known/trusted computing devices via one or more messages that include the updated network credentials, which may be encrypted using public keys associated with the known/trusted computing devices.

### BACKGROUND

As more devices become Internet-capable, wireless networks have grown in size and complexity. When network credentials for a wireless network are changed, devices that were previously associated with the wireless network must be provided with new network credentials to communicate with the wireless network. This can be burdensome for some users and devices. The burden may be even greater depending on capabilities of a device that requires the new network credentials. For example, the device may be difficult to access (e.g., a mounted camera) or the device may not have a user interface (e.g., smart devices, Internet-capable appliances, Internet-capable sensors, etc.).

### SUMMARY

It is to be understood that both the following general description and the following detailed description are exemplary and explanatory only and are not restrictive, as claimed. Methods, systems, and apparatuses for network credential management are described herein. A network device, such as an access point, a router, or a gateway device, may establish (e.g., broadcast) a network. Computing device may be required to use network credentials to communicate with the network. A computing device may send a request to communicate with the network to the network device. The request may include the network credentials and a public key associated with the computing device. The network device may allow the computing device to communicate with the network when it is determined that the network credentials are valid. The network device may receive and/or determine an update to the network credentials. The network device may securely provide the updated network credentials to the computing device. For example, the network device may determine that the public key associated with the computing device is still valid, and the network device may send the updated network credentials to the computing device.

The updated network credentials may be sent to the client device via one or more messages sent by the network device. The one or more messages may include the updated network credentials encrypted using the public key. The client device may receive the one or more messages and use a corresponding private key to decrypt the updated network credentials. The client device may send a second request to communicate with the network to the network device. The network device may allow the client device to communicate with the network when it is determined that the network credentials sent with the second request (e.g., the new network name and/or the new network password) are valid.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and/or examples and together with the description, serve to explain the principles of the methods and systems:

FIGS. 1A and 1B show an example network;

FIG. 2 shows example communication flows for an example network;

FIG. 3 shows a flowchart of an example method;

FIG. 4 shows a flowchart of an example method;

FIG. 5 shows a flowchart of an example method;

FIG. 6 shows a flowchart of an example method; and

FIG. 7 shows a block diagram of an example computing device.

### DETAILED DESCRIPTION

Before the present methods and systems are described, it is to be understood that the methods and systems are not limited to specific methods, specific components, or to particular implementations. It is also to be understood that the terminology used herein is for the purpose of describing particular embodiments and/or examples only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment and/or example includes from the one particular value and/or to the other particular value. Similarly, when values are expressed as approximations, by use of the antecedent “about,” it will be understood that the particular value forms another embodiment and/or example. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment and/or example. “Such as” is not used in a restrictive sense, but for explanatory purposes.

Described are components that can be used to perform the described methods and systems. These and other components are described herein, and it is understood that when combinations, subsets, interactions, groups, etc. of these components are described that while specific reference of each various individual and collective combinations and permutation of these may not be explicitly described, each is specifically contemplated and described herein, for all methods and systems. This applies to all aspects of this application including, but not limited to, steps in described methods. Thus, if there are a variety of additional steps that can be performed it is understood that each of these additional steps can be performed with any specific embodiment and/or example or combination of embodiments and/or examples of the described methods.

The present methods and systems may be understood more readily by reference to the following detailed description and the examples included therein and to the Figures and their previous and following description. As will be appreciated by one skilled in the art, the methods and systems may take the form of an entirely hardware embodiment and/or example, an entirely software embodiment and/or example, or an embodiment and/or example combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, flash memory internal or removable, or magnetic storage devices.

Embodiments and/or examples of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Methods, systems, and apparatuses for network credential management are described herein. A network device may establish (e.g., broadcast) a network. The network device may be an access point, a router, a gateway device, a network hub, a repeater, a bridge, and/or the like. The network may be a wireless network, such as a WiFi network. To communicate with the network, client devices may be required to send valid network credentials to the network device. The network credentials may include, for example, a network name and a network password.

A client device may generate a pair of encryption keys, such as a public key and an associated private key. The client device may be a computing device, a user device, a tablet, a laptop, a desktop, a mobile device, a set-top box, a sensor, a camera, an appliance, or a smart device, and/or the like. The public key have a time to live (“TTL”) element indicating a duration of time during which the public key is valid (e.g., unexpired). The client device may comprise one or more wireless interfaces, each having an assigned Media Access Control (“MAC”) address. The public key and/or the private key may identify each MAC address of each of the one or more wireless interfaces. The client device may send the public key and a first request to communicate with the network to the network device (e.g., using one of the one or more wireless interfaces).

The first request may comprise the network credentials. For example, the client device may send the public key to the network device as part of the first request. The client device may send the public key to the network device separate from the first request. For example, the client device may send the public key to the network device as part of a communication (e.g., a message) that is separate from the first request. The client device may send the first request directed to a first communication port of the network device using a first wireless interface (e.g., an 802.11 radio), and the client device may send the public key directed to another communication port of the network device using a second wireless interface (e.g., Bluetooth™). The public key may identify the MAC address of the first wireless interface and the MAC address of the second wireless interface. In this way, the network device may receive the public key using the other communication port yet nonetheless be able to determine that the public key was sent by the same client device that sent the first request directed to the first communication port. The network device may allow the client device to communicate with the network when it is determined that the network credentials sent by the client device are valid.

The network device may receive and/or determine an update to the network credentials. For example, the network device may receive and/or determine the update to the network credentials based on one or more of a network rule, an instruction received by the network device by a user device, an instruction received by the network device from an administrative device, a combination thereof, and/or the like. The updated network credentials may include, for example, a new network name and/or a new network password. The network device may reestablish (e.g., rebroadcast) the network such that client devices may be required to provide the updated network credentials to the network device to be allowed to communicate the network. The network device may securely provide the updated network credentials to client devices listed in a network routing table that are associated with a valid public key. For example, the network device may determine that the public key associated with the client device is still valid based on the TTL element of the public key. The network device may encrypt the updated network credentials using the public key associated with the client device.

The encrypted network credentials may be sent (e.g., broadcasted) to the client device via one or more messages. The one or more messages may be network messages, broadcast frames, wireless network frames, Internet Protocol packets, beacon frames, a combination thereof, and/or the like. For example, the encrypted network credentials may be sent to the client device by appending the encrypted network credentials to one or more wireless network frames emitted by the network device. The network device may emit/broadcast the one or more wireless network frames as part of broadcasting the network. For example, the one or more wireless network frames may include the new network name as well as other identifying information for the network and/or the network device (e.g., channel identifier(s), MAC address(es), etc.). The one or more wireless network frames may be received by any client device that is within a broadcast proximity of the network device. The network device may broadcast the one or more wireless network frames until the TTL element expires and/or until the network device receives a request to communicate with the network from the client device including the updated network credentials. The client device may receive the one or more wireless network frames (e.g., using one of the one or more wireless interfaces) and decrypt the encrypted network credentials using the private key to determine the new network name and/or the new network password. The client device may send a second request to communicate with the network to the network device (e.g., using one of the one or more wireless interfaces). The second request may comprise the new network password and/or the new network name. The network device may store the public key in a new entry of the network routing table along with the updated network credentials. The network device may delete an existing entry in the network routing table identifying the public key of the client device and the prior network credentials. The network device may allow the client device to communicate with the network when it is determined that the updated network credentials (e.g., the new network password and/or the new network name) are valid. The network device may receive at least one communication from the client device via the network. For example, the at least one communication may be received by the network device after the network device determines that the updated network credentials received from the client device are valid and allows the client device to communicate with the network.

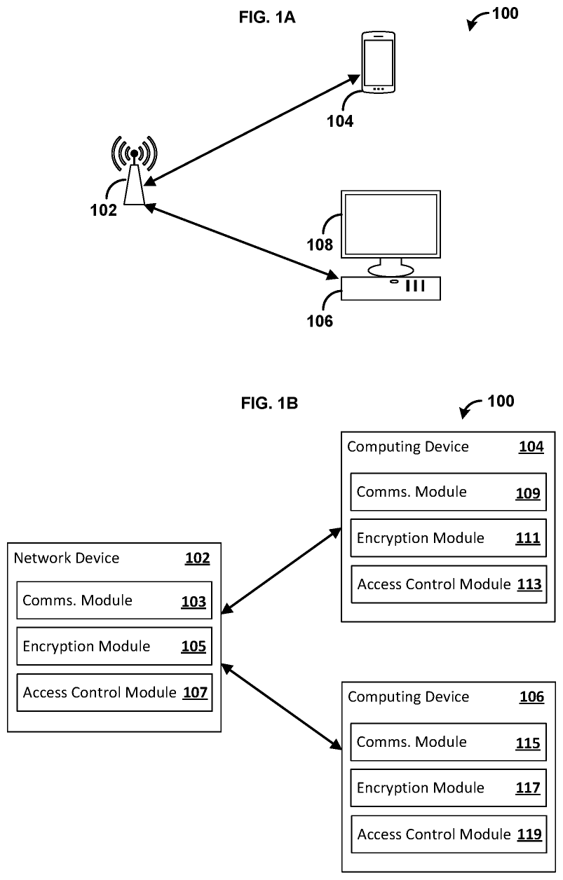

Turning now to FIG. 1A, an example network 100 is shown. The network 100 may comprise a network device 102 that provides wired and/or wireless infrastructure for the network 100. The network device 102 may be an access point, a router, a gateway device, a network hub, a repeater, a bridge, a combination thereof, and/or the like. The network 100 may comprise a first computing device 104 and a second computing device 106. The first computing device 104 may be a user device, a mobile device, a tablet, a laptop, a desktop, a set-top box, a sensor, a camera, an appliance, a smart device, and/or the like. The second computing device 106 may be a user device, a mobile device, a tablet, a laptop, a desktop, a set-top box, a media player, a sensor, a camera, an appliance, a smart device, and/or the like. For example, the second computing device 106 may provide an interface via a display 108 in communication with the second computing device 106.

FIG. 1B shows a block diagram illustrating an example configuration of the network 100. While FIG. 1B shows the network 100 as having both the first computing device 104 and the second computing device 106, it is to be understood that the network 100 may only have one computing device (e.g., the first computing device 104 or the second computing device 106). Additionally, it is to be understood that the network 100 may have more than two computing devices. The example configuration of the network 100 shown in FIG. 1B is one or many possible configurations of the example network 100. The network device 102 may comprise a communications module 103, an encryption module 105, and/or an access control module 107. The communications module 103 may be used to send and/or receive network communications, such as broadcasting a wireless network and sending/receiving data to/from client devices associated with the network 100. The encryption module 105 may be used to encrypt network credentials for a wireless network, such as a network name and/or a network password. The access control module 107 may be a secure repository of the network device 102 used to store a routing table(s). The routing table(s) may list public keys for client devices, Media Access Control (“MAC”) addresses for client devices, network credentials, etc.

The first computing device 104 may comprise a communications module 109, an encryption module 111, and/or an access control module 113. The communications module 109 may be used to send and/or receive network communications, such as wireless network communications sent to and/or received from the network device 102. The communications module 109 may comprise one or more wireless interfaces, such as an 802.11 radio, a ZigBee radio, a Z-Wave radio, or a Bluetooth™ radio. Each of the one or more wireless interfaces may have an assigned MAC address. The encryption module 111 may be used to generate a public key/private key pair associated with the first computing device 104. The encryption module 111 may be used decrypt network credentials for a wireless network, such as a network name and/or a network password, received from the network device 102. The access control module 113 may be a secure repository of the first computing device 104 used to store public key/private key pairs, network credentials, etc.

The second computing device 106 may have a communications module 115, an encryption module 117, and an access control module 119. The communications module 115 may be used to send and/or receive network communications, such as wireless network communications sent to and/or received from the network device 102. The communications module 115 may comprise one or more wireless interfaces, such as an 802.11 radio, a ZigBee radio, a Z-Wave radio, or a Bluetooth™ radio. Each of the one or more wireless interfaces may have an assigned MAC address. The encryption module 117 may be used to generate a public key/private key pair associated with the second computing device 106. The encryption module 117 may be used decrypt network credentials for a wireless network, such as a network name and/or a network password, received from the network device 102. The access control module 119 may be a secure repository of the second computing device 106 used to store public key/private key pairs, network credentials, etc.

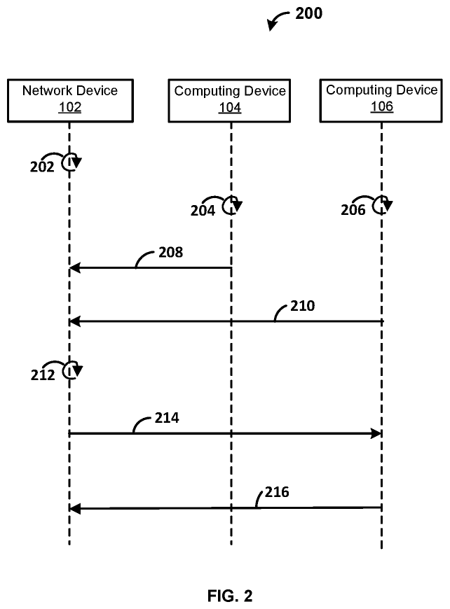

Functionality of each of the devices of the network 100 will be described with reference to FIG. 2, which shows example communication flows for the network 100. While FIG. 2 shows both the first computing device 104 and the second computing device 106, it is to be understood that the functionality described with reference to FIG. 2 may be equally applicable when only one computing device (e.g., the first computing device 104 or the second computing device 106) is present. Additionally, it is to be understood that the functionality described with reference to FIG. 2 may be equally applicable when more than two computing devices are present. The configuration of the network 100 shown in FIG. 2 is one or many possible configurations.

At communication flow 202, the network device 102 may establish (e.g., broadcast) a network using the communications module 103. The network may be a wireless network, such as a WiFi network. To communicate with the wireless network, each of the first computing device 104 and the second computing device 106 may be required to provide network credentials to the network device 102. The network credentials may include, for example, a network name and a network password. The network name may be an identifier for the network, such as a Service Set Identifier (“SSID”). The network password may be a string of characters including letters, digits, and/or other symbols.

At communication flow 204, the first computing device 104 may determine a first public key and a first private key associated with the first public key using the encryption module 111. The first public key have a time to live (“TTL”) element indicating a duration of time during which the first public key is valid (e.g., unexpired). The first public key and the first private key may be associated with one or more MAC addresses of the one or more wireless interfaces of the first computing device 104. For example, the first public key and/or the first private key may identify one or more MAC addresses of the one or more wireless interfaces of the first computing device 104. At communication flow 206, the second computing device 106 may determine a second public key and a second private key associated with the second public key using the encryption module 119. The second public key have a TTL element indicating a duration of time during which the second public key is valid (e.g., unexpired). By way of example, the second computing device 106 may determine the second public key and the second private key at a same time the first computing device 104 determines the second public key and the second private key at communication flow 204. The second public key and the second private key may be associated with one or more MAC addresses of the one or more wireless interfaces of the second computing device 106. For example, the second public key and/or the second private key may identify one or more MAC addresses of the one or more wireless interfaces of the second computing device 106.

At communication flow 208, the first computing device 104 may send the first public key and a request to communicate with the wireless network to the network device 102 using one of the one or more wireless interfaces of the communications module 109. By way of example, the request may comprise the network credentials. The first computing device 104 may send the first public key to the network device 102 separately from the request. For example, the first computing device 104 may send the request directed to a first communication port of the network device 102 using a first wireless interface (e.g., an 802.11 radio) of the communications module 109, and the first computing device 104 may send the first public key directed to another communication port of the network device 102 using a second wireless interface (e.g., Bluetooth™) of the communications module 109. The first public key may identify the MAC address of the first wireless interface and the MAC address of the second wireless interface of the first computing device 104. The network device 102 may determine that the first public key was received from the first computing device 104 based on the MAC address associated with the request corresponding to the MAC address of the first wireless interface identified by the first public key. In this way, the network device 102 may receive the first public key using the other communication port yet nonetheless be able to determine that the first public key was sent by the first computing device 104.

The network device 102 may receive the request and the first public key from the first computing device 104 using the communications module 103. The network device 102 may store the first public key. For example, the network device 102 may store the first public key in a network routing table of the access control module 107. The first public key may be stored in the network routing table along with the network credentials. The network device 102 may determine that the network credentials received from the first computing device 104 are valid. The network device may allow the first computing device 104 to communicate with the wireless network based on the network credentials being valid. The network device may deny the first computing device 104 access to the wireless network based on the network credentials being invalid.

At communication flow 210, the second computing device 106 may send the second public key and a request to communicate with the wireless network to the network device 102 using one of the one or more wireless interfaces of the communications module 115. By way of example, the request may comprise the network credentials. The second computing device 106 may send the second public key to the network device 102 separately from the request. For example, the second computing device 106 may send the request directed to a first communication port of the network device 102 using a first wireless interface (e.g., an 802.11 radio) of the communications module 115, and the second computing device 106 may send the second public key directed to another communication port of the network device 102 using a second wireless interface (e.g., Bluetooth™) of the communications module 115. The second public key may identify the MAC address of the first wireless interface and the MAC address of the second wireless interface of the second computing device 106. The network device 102 may determine that the second public key was received from the second computing device 106 based on the MAC address associated with the request corresponding to the MAC address of the first wireless interface identified by the second public key. In this way, the network device 102 may receive the second public key using the other communication port yet nonetheless be able to determine that the second public key was sent by the second computing device 106.

The network device 102 may receive the request and the second public key from the second computing device 106 using the communications module 103. The network device 102 may store the second public key. For example, the network device 102 may store the second public key in a network routing table of the access control module 107. The second public key may be stored in the network routing table along with the network credentials. The network device 102 may determine that the network credentials received from the second computing device 106 are valid. The network device may allow the second computing device 106 to communicate with the wireless network based on the network credentials being valid.

At communication flow 212, the network device 102 may determine an update to the network credentials. For example, the network device 102 may receive an instruction that causes the network device 102 to determine the update to the network credentials. The instruction may be received from a user device, such as a mobile device, a computing device, etc. (not shown), with administrative access to the network device 102. The user device may send the instruction to the network device 102 via a web browser interface, a mobile device application, or any other suitable interface that permits the user device to communicate with the network device 102. Additionally, or in the alternative, the user device may send the updated network credentials to the network device 102 as part of a configuration, or a reconfiguration, package. For example, the network device 102 may determine the update to the network credentials based on a network rule. The network rule may cause the network device 102 to determine the update to the network credentials at a specific date and/or time (e.g., a date and/or time defined by the network rule) or after a specific duration of time has elapsed (e.g., a quantity of hours, days, months, etc., defined by the network rule). The updated network credentials may include, for example, a new network name (e.g., a new SSID) and/or a new network password.

Also at communication flow 212, the network device 102 may reestablish (e.g., rebroadcast) the network such that each of the first computing device 104 and the second computing device 106 may be required to provide the updated network credentials to the network device 102 to communicate with the wireless network. The network device 102 may securely provide the updated network credentials to client devices (e.g., the first computing device 104 and/or the second computing device 106) that are associated with a valid public key. For example, the network device 102 may determine that the first public key associated with the first computing device 104 is no longer valid (e.g., expired). The network device 102 may determine that the first public key is no longer valid based on the TTL element associated with the first public key being expired. For example, the network device 102 may determine that the second public key associated with the second computing device 106 is still valid (e.g., not expired). The network device 102 may determine the second public key is still valid based on the TTL element associated with the second public key being unexpired. The network device 102 may send the updated network credentials to the second computing device 106, since the TTL element associated with the second public key is unexpired. The network device 102 may not send the updated network credentials to the first computing device 104, since the TTL element associated with the first public key is expired. The network device 102 may determine that the second computing device 106 has not sent a request to join the wireless network including the updated network credentials. The network device 102 may make this determination by comparing the updated network credentials to the network credentials stored with the second public key in the network routing table of the access control module 107. The network device 102 may encrypt the updated network credentials using the second public key.

At communication flow 214, the network device 102 may broadcast information identifying the wireless network, such as a network name (e.g., SSID), by sending (e.g., emitting) one or more messages via the communications module 103. The one or more messages may be network messages, broadcast frames, wireless network frames, Internet Protocol packets, beacon frames, a combination thereof, and/or the like. For example, the one or more messages may be one or more wireless network frames (e.g., 802.11 frames) sent via a wireless channel (e.g., an 802.11 channel) and the communications module 103. The encrypted network credentials may be sent to the second computing device 106 via the one or more messages. For example, the encrypted network credentials may be broadcast to the second computing device 106 by appending the encrypted network credentials to one or more of the wireless network frames. The network device 102 may broadcast the one or more wireless network frames appended with the encrypted network credentials using the same wireless channel. The network device 102 may emit/broadcast the one or more wireless network frames as part of broadcasting the network. For example, the one or more wireless network frames may include the new network name as well as other identifying information for the network and/or the network device 102 (e.g., channel identifier(s), MAC address(es), etc.). The one or more wireless network frames may be received by any client device that is within a broadcast proximity of the network device 102.

The network device 102 may broadcast the one or more messages until the TTL element associated with the second public key expires and/or until the network device 102 receives a request to communicate with the wireless network from the second computing device 106 including the updated network credentials. The second computing device 106 may receive the one or more messages using one of the one or more wireless interfaces of the communications module 115. For example, the second computing device 106 may receive the one or more messages as one or more wireless network frames appended with the encrypted network credentials. The second computing device 106 may receive the one or more messages prior to the TTL element associated with the second public key expiring. The second computing device 106 may decrypt the encrypted network credentials using the second private key stored in the access control module 119.

At communication flow 216, the second computing device 106 may send another request to communicate with the wireless network to the network device 102 using one of the one or more wireless interfaces of the communications module 115. The network device 102 may receive the request to communicate with the wireless network from the second computing device 106. The second request may comprise the updated network credentials. The network device 102 may determine that the updated network credentials are valid. The network device 102 may allow the second computing device 106 to communicate with the wireless network based on the updated network credentials being valid. The network device 102 may receive at least one communication from the second computing device 106 via the wireless network. For example, the at least one communication may be received by the network device 102 after the network device 102 determines that the updated network credentials received from the second computing device 106 are valid and allows the second computing device 106 to communicate with the wireless network.

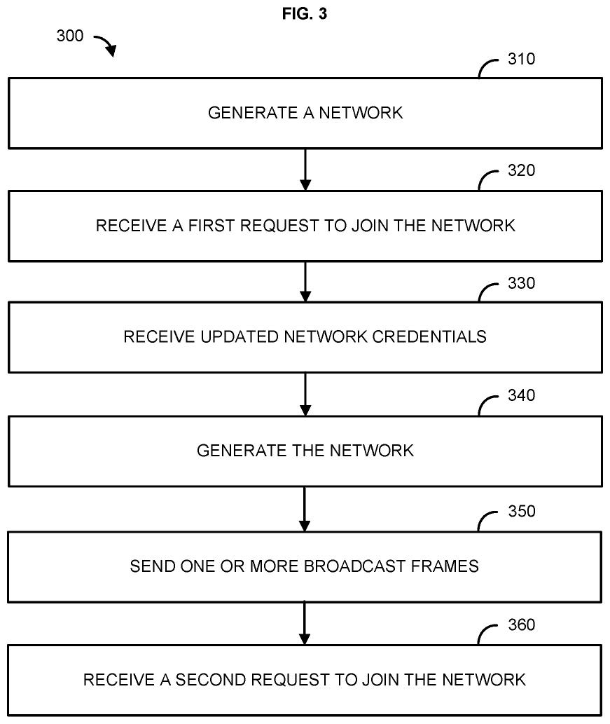

Turning now to FIG. 3, a flowchart of an example method 300 for network credential management is shown. The method 300 may be implemented using the network device 102. At step 310, a network may be generated by a first computing device. The first computing device may be an access point, a router, a gateway device, a network hub, a repeater, a bridge, and/or the like. The network may be a wireless network, such as a WiFi network. To communicate with the network, client devices may be required to provide network credentials to the first computing device. The network credentials may include, for example, a network name and a network password. The network name may be an identifier for the network, such as an SSID. The network password may be a string of characters including letters, digits, and/or other symbols.

A second computing device (e.g., a client device) may determine a public key and a private key associated with the public key. The second computing device may be a user device, a tablet, a laptop, a desktop, a mobile device, a set-top box, a sensor, a camera, an appliance, or a smart device, and/or the like. The second computing device may comprise one or more wireless interfaces, such as an 802.11 radio, a ZigBee radio, a Z-Wave radio, or a Bluetooth™ radio. Each of the one or more wireless interfaces may have an assigned Media Access Control (“MAC”) address. The public key and the private key may be associated with one or more MAC addresses of the one or more wireless interfaces. For example, the public key and/or the private key may identify one or more MAC addresses of the one or more wireless interfaces.

At step 320, the first computing device may receive a first request to communicate with the network. The first request may be sent by the second computing device. The second computing device may send the first request along with the public key to the first computing device. The first request may comprise the network credentials. The first computing device may store the public key. For example, the first computing device may store the public key in a network routing table. The public key may be stored in the network routing table along with the network credentials. The first computing device may allow the second computing device to communicate with the network based on the first request. The first computing device may determine that the network credentials are valid. The first computing device may allow the second computing device to communicate with the network based on the network credentials being valid.

The second computing device may send the public key to the first computing device separate from the first request. For example, the second computing device may send the first request directed to a first communication port of the first computing device using a first wireless interface (e.g., an 802.11 radio), and the second computing device may send the public key directed to another communication port of the first computing device using a second wireless interface (e.g., Bluetooth™). The public key may identify the MAC address of the first wireless interface and the MAC address of the second wireless interface. The first computing device may determine that the public key was received from the client device based on the MAC address associated with the first request corresponding to the MAC address of the first wireless interface identified by the public key.

At step 330, the first computing device may receive updated network credentials. For example, the first computing device may receive an instruction that includes the updated network credentials. The instruction may be received from a user device, such as a mobile device, a computing device, etc., with administrative rights to the first computing device. The updated network credentials may include, for example, a new network name (e.g., a new SSID) and/or a new network password.

At step 340, the first computing device may reestablish (e.g., rebroadcast) the network such that client devices may be required to provide the updated network credentials to the first computing device to communicate with the network. The first computing device may determine which client device(s) listed in the network routing table has not sent a request to communicate with the network including the updated network credentials. For any such client device(s), the first computing device may determine whether the public key associated with the client device(s) has expired. For example, the first computing device may determine that the second computing device has not sent a request to communicate with the network including the updated network credentials. The first computing device may make this determination by comparing the updated network credentials to the network credentials stored in the network routing table with the public key associated with the second computing device. The first computing device may determine that the public key associated with the second computing device has not expired based on a time to live (“TTL”) element of the public key. The first computing device may encrypt the updated network credentials using the public key associated with the second computing device (e.g., based on determining that the TTL element is unexpired).

The first computing device may broadcast information identifying the network, such as a network name (e.g., SSID), by sending (e.g., emitting) one or more messages. The one or more messages may be network messages, broadcast frames, wireless network frames, Internet Protocol packets, beacon frames, a combination thereof, and/or the like. For example, the first computing device may send the one or more messages as one or more wireless network frames (e.g., 802.11 frames) via a wireless channel (e.g., an 802.11 channel). The encrypted network credentials may be sent to the second computing device via the one or more messages. For example, the encrypted network credentials may be sent to the second computing device via the one or more messages by appending the encrypted network credentials to one or more of the wireless network frames. At step 350, the first computing device may send the one or more messages. For example, the first computing device may send one or more of the wireless network frames appended with the encrypted network credentials using the same wireless channel. The first computing device may emit/broadcast the one or more wireless network frames as part of broadcasting the network. For example, the one or more wireless network frames may include the new network name as well as other identifying information for the network and/or the first computing device (e.g., channel identifier(s), MAC address(es), etc.). The one or more wireless network frames may be received by any computing device that is within a broadcast proximity of the first computing device.

The first computing device may send the one or more messages until the TTL element expires and/or until the network device receives a request to communicate with the network from the client device including the updated network credentials. The second computing device may receive the one or more messages (e.g., using one of the one or more wireless interfaces). For example, the second computing device may receive the one or more messages as one or more of the wireless network frames appended with the encrypted network credentials. The second computing device may receive the one or more messages prior to the TTL element of the public key expiring. The second computing device may decrypt the encrypted network credentials using the private key. The second computing device may send a second request to communicate with the network to the first computing device. At step 360, the first computing device may receive the second request to communicate with the network from the second computing device. The first computing device may allow the second computing device to communicate with the network based on the second request. The second request may comprise the updated network credentials. The first computing device may determine that the updated network credentials are valid. The first computing device may allow the second computing device to communicate with the network based on the updated network credentials being valid. The first computing device may receive at least one communication from the second computing device via the network. For example, the at least one communication may be received by the first computing device after the first computing device determines that the updated network credentials received from the second computing device are valid and allows the second computing device to communicate with the network.

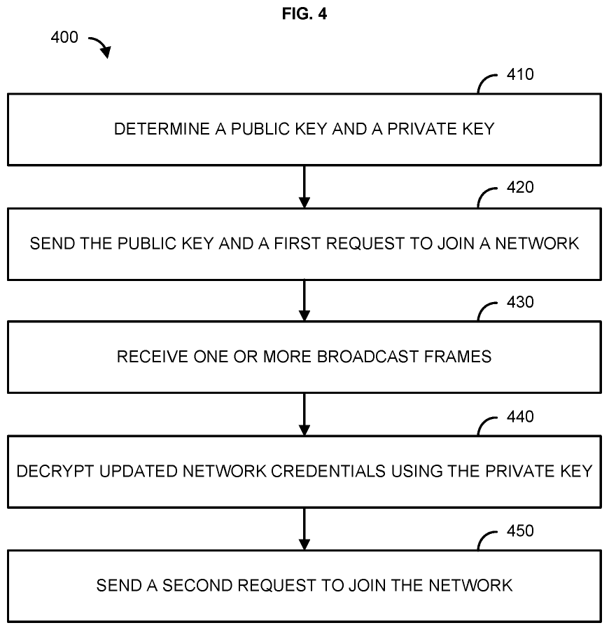

Turning now to FIG. 4, a flowchart of an example method 400 for network credential management is shown. The method 400 may be implemented using either of the first computing device 104 or the second computing device 106. At step 410, a first computing device (e.g., a client device) may determine a public key and a private key associated with the public key. The first computing device may be a user device, a tablet, a laptop, a desktop, a mobile device, a set-top box, a sensor, a camera, an appliance, or a smart device, and/or the like. The first computing device may comprise one or more wireless interfaces, such as an 802.11 radio, a ZigBee radio, a Z-Wave radio, or a Bluetooth™ radio. Each of the one or more wireless interfaces may have an assigned Media Access Control (“MAC”) address. The public key and the private key may be associated with one or more MAC addresses of the one or more wireless interfaces. For example, the public key and/or the private key may identify one or more MAC addresses of the one or more wireless interfaces.

A network may be generated by a second computing device. The second computing device may be an access point, a router, a gateway device, a network hub, a repeater, a bridge, and/or the like. The network may be a wireless network, such as a WiFi network. To communicate with the network, the first computing device may be required to provide network credentials to the second computing device. The network credentials may include, for example, a network name and a network password. The network name may be an identifier for the network, such as an SSID. The network password may be a string of characters including letters, digits, and/or other symbols.

At step 420, the first computing device may send a first request to communicate with the network to the second computing device. The first computing device may send the first request along with the public key to the second computing device. The first request may comprise the network credentials. The second computing device may store the public key. For example, the second computing device may store the public key in a network routing table. The public key may be stored in the network routing table along with the network credentials. The second computing device may allow the first computing device to communicate with the network based on the first request. The second computing device may determine that the network credentials are valid. The second computing device may allow the first computing device to communicate with the network based on the network credentials being valid.

The first computing device may send the public key to the second computing device separate from the first request. For example, the first computing device may send the first request directed to a first communication port of the second computing device using a first wireless interface (e.g., an 802.11 radio), and the first computing device may send the public key directed to another communication port of the second computing device using a second wireless interface (e.g., Bluetooth™). The public key may identify the MAC address of the first wireless interface and the MAC address of the second wireless interface. The second computing device may determine that the public key was received from the first computing device based on the MAC address associated with the first request corresponding to the MAC address of the first wireless interface identified by the public key.

The second computing device may receive and/or determine an update to the network credentials. For example, the second computing device may receive an instruction that causes the second computing device to determine the update to the network credentials. The instruction may be received from a user device, such as a mobile device, a computing device, etc. For example, the second computing device may determine the update to the network credentials based on a network rule. The network rule may cause the second computing device to determine the update to the network credentials at a specific date and/or time (e.g., a date and/or time defined by the network rule) or after a specific duration of time has elapsed (e.g., a quantity of hours, days, months, etc., defined by the network rule). The updated network credentials may include, for example, a new network name (e.g., a new SSID) and/or a new network password.

The second computing device may reestablish (e.g., rebroadcast) the network such that the first computing device may be required to provide the updated network credentials to the second computing device to communicate with the network. The second computing device may determine which client device(s) listed in the network routing table has not sent a request to communicate with the network including the updated network credentials. For any such client device(s), the second computing device may determine whether the public key associated with the client device(s) has expired. For example, the second computing device may determine that the first computing device has not sent a request to communicate with the network including the updated network credentials. The second computing device may make this determination by comparing the updated network credentials to the network credentials stored in the network routing table with the public key associated with the first computing device. The second computing device may determine that the public key associated with the first computing device has not expired based on a time to live (“TTL”) element of the public key. The second computing device may encrypt the updated network credentials using the public key associated with the first computing device (e.g., based on determining that the TTL element is unexpired).

The second computing device may send information identifying the network, such as a network name (e.g., SSID), by sending (e.g., emitting) one or more messages. The one or more messages may be network messages, broadcast frames, wireless network frames, Internet Protocol packets, beacon frames, a combination thereof, and/or the like. For example, the second computing device may send the one or more messages as one or more wireless network frames (e.g., 802.11 frames) via a wireless channel (e.g., an 802.11 channel). The encrypted network credentials may be sent to the first computing device via the one or more messages. For example, the encrypted network credentials may be sent to the first computing device via the one or more messages by appending the encrypted network credentials to one or more of the wireless network frames. The second computing device may send the one or more messages. For example, the second computing device may send one or more of the wireless network frames appended with the encrypted network credentials using the same wireless channel. The second computing device may emit/broadcast the one or more wireless network frames as part of broadcasting the network. For example, the one or more wireless network frames may include the new network name as well as other identifying information for the network and/or the second computing device (e.g., channel identifier(s), MAC address(es), etc.). The one or more wireless network frames may be received by any computing device that is within a broadcast proximity of the second computing device. The second computing device may send the one or more messages until the TTL element expires and/or until the second computing device receives a request to communicate with the network from the first computing device including the updated network credentials.

At step 430, the first computing device may receive the one or more messages (e.g., using one of the one or more wireless interfaces). For example, the first computing device may receive the one or more messages as one or more of the wireless network frames appended with the encrypted network credentials. The first computing device may receive the one or more messages prior to the TTL element of the public key expiring. At step 440, the first computing device may decrypt the encrypted network credentials. For example, the first computing device may decrypt the encrypted network credentials using the private key. At step 450, the first computing device may send a second request to communicate with the network to the second computing device. The second computing device may receive the second request to communicate with the network from the first computing device. The second request may comprise the updated network credentials. The second computing device may allow the first computing device to communicate with the network based on the second request. The second computing device may determine that the updated network credentials are valid. The second computing device may allow the first computing device to communicate with the network based on the updated network credentials being valid. The second computing device may receive at least one communication from the first computing device via the network. For example, the at least one communication may be received by the second computing device after the second computing device determines that the updated network credentials received from the first computing device are valid and allows the first computing device to communicate with the network.

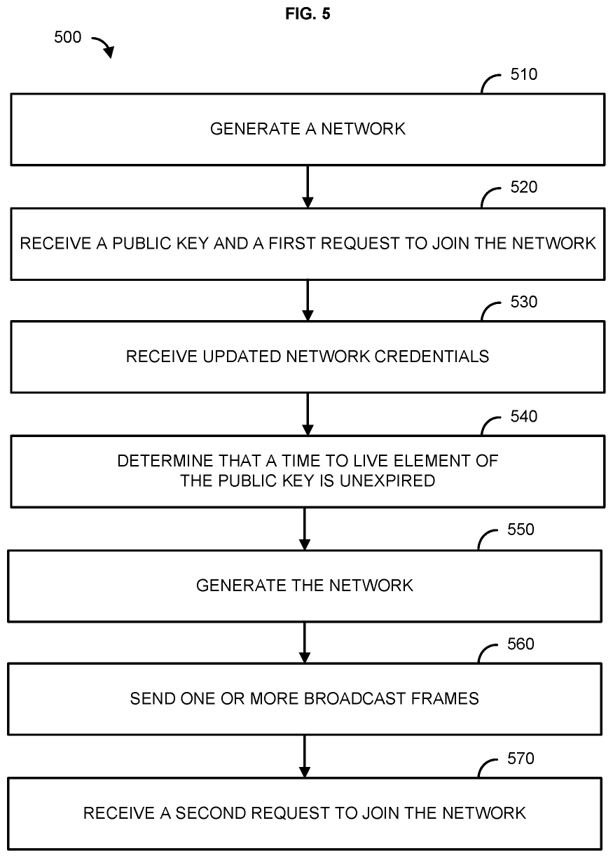

Turning now to FIG. 5, a flowchart of an example method 500 for network credential management is shown. The method 500 may be implemented using the network device 102. At step 510, a network may be generated by a first computing device. The first computing device may be an access point, a router, a gateway device, a network hub, a repeater, a bridge, and/or the like. The network may be a wireless network, such as a WiFi network. To communicate with the network, client devices may be required to provide network credentials to the first computing device. The network credentials may include, for example, a network name and a network password. The network name may be an identifier for the network, such as an SSID. The network password may be a string of characters including letters, digits, and/or other symbols.

A second computing device (e.g., a client device) may determine a public key and a private key associated with the public key. The second computing device may be a user device, a tablet, a laptop, a desktop, a mobile device, a set-top box, a sensor, a camera, an appliance, or a smart device, and/or the like. The second computing device may comprise one or more wireless interfaces, such as an 802.11 radio, a ZigBee radio, a Z-Wave radio, or a Bluetooth™ radio. Each of the one or more wireless interfaces may have an assigned Media Access Control (“MAC”) address. The public key and the private key may be associated with one or more MAC addresses of the one or more wireless interfaces. For example, the public key and/or the private key may identify one or more MAC addresses of the one or more wireless interfaces.

At step 520, the first computing device may receive a first request to communicate with the network and the public key. The first request and the public key may be sent by the second computing device. The first request may comprise the network credentials. The first computing device may store the public key. For example, the first computing device may store the public key in a network routing table. The public key may be stored in the network routing table along with the network credentials. The first computing device may allow the second computing device to communicate with the network based on the first request. The first computing device may determine that the network credentials are valid. The first computing device may allow the second computing device to communicate with the network based on the network credentials being valid.

The second computing device may send the public key to the first computing device separate from the first request. For example, the second computing device may send the first request directed to a first communication port of the first computing device using a first wireless interface (e.g., an 802.11 radio), and the second computing device may send the public key directed to another communication port of the first computing device using a second wireless interface (e.g., Bluetooth™). The public key may identify the MAC address of the first wireless interface and the MAC address of the second wireless interface. The first computing device may determine that the public key was received from the client device based on the MAC address associated with the first request corresponding to the MAC address of the first wireless interface identified by the public key.

At step 530, the first computing device may receive and/or determine an update to the network credentials. For example, the first computing device may receive an instruction that causes the first computing device to determine the update to the network credentials. The instruction may be received from a user device, such as a mobile device, a computing device, etc. For example, the first computing device may determine the update to the network credentials based on a network rule. The network rule may cause the first computing device to determine the update to the network credentials at a specific date and/or time (e.g., a date and/or time defined by the network rule) or after a specific duration of time has elapsed (e.g., a quantity of hours, days, months, etc., defined by the network rule). The updated network credentials may include, for example, a new network name (e.g., a new SSID) and/or a new network password.

The first computing device may determine which client device(s) listed in the network routing table has not sent a request to communicate with the network including the updated network credentials. For any such client device(s), the first computing device may determine whether the public key associated with the client device(s) has expired. For example, the first computing device may determine that the second computing device has not sent a request to communicate with the network including the updated network credentials. The first computing device may make this determination by comparing the updated network credentials to the network credentials stored in the network routing table with the public key associated with the second computing device. At step 540, the first computing device may determine that the public key associated with the second computing device has not expired based on a time to live (“TTL”) element of the public key. The first computing device may encrypt the updated network credentials using the public key associated with the second computing device (e.g., based on determining that the TTL element is unexpired).

At step 550, the first computing device may reestablish (e.g., rebroadcast) the network such that client devices may be required to provide the updated network credentials to the first computing device to communicate with the network. The first computing device may broadcast information identifying the network, such as a network name (e.g., SSID), by sending (e.g., emitting) one or more messages. The one or more messages may be network messages, broadcast frames, wireless network frames, Internet Protocol packets, beacon frames, a combination thereof, and/or the like. For example, the first computing device may send the one or more messages as one or more wireless network frames (e.g., 802.11 frames) via a wireless channel (e.g., an 802.11 channel). The encrypted network credentials may be sent to the second computing device via the one or more messages. For example, the encrypted network credentials may be sent to the second computing device via the one or more messages by appending the encrypted network credentials to one or more of the wireless network frames.

At step 560, the first computing device may send the one or more messages. For example, the first computing device may send the one or more messages as one or more of the wireless network frames appended with the encrypted network credentials using the same wireless channel. The first computing device may emit/broadcast the one or more wireless network frames as part of broadcasting the network. For example, the one or more wireless network frames may include the new network name as well as other identifying information for the network and/or the first computing device (e.g., channel identifier(s), MAC address(es), etc.). The one or more wireless network frames may be received by any computing device that is within a broadcast proximity of the first computing device. The first computing device may send the one or more wireless network frames until the TTL element expires and/or until the first computing device receives a request to communicate with the network from the second computing device including the updated network credentials. The second computing device may receive the one or more wireless messages (e.g., using one of the one or more wireless interfaces). For example, the second computing device may receive the one or more messages as one or more of the wireless network frames appended with the encrypted network credentials. The second computing device may receive the one or more messages prior to the TTL element of the public key expiring. The second computing device may decrypt the encrypted network credentials using the private key. The second computing device may send a second request to communicate with the network to the first computing device. At step 570, the first computing device may receive the second request to communicate with the network from the second computing device. The second request may comprise the updated network credentials. The first computing device may allow the second computing device to communicate with the network based on the second request. The first computing device may determine that the updated network credentials are valid. The first computing device may allow the second computing device to communicate with the network based on the updated network credentials being valid. The first computing device may receive at least one communication from the second computing device via the network. For example, the at least one communication may be received by the first computing device after the first computing device determines that the updated network credentials received from the second computing device are valid and allows the second computing device to communicate with the network.

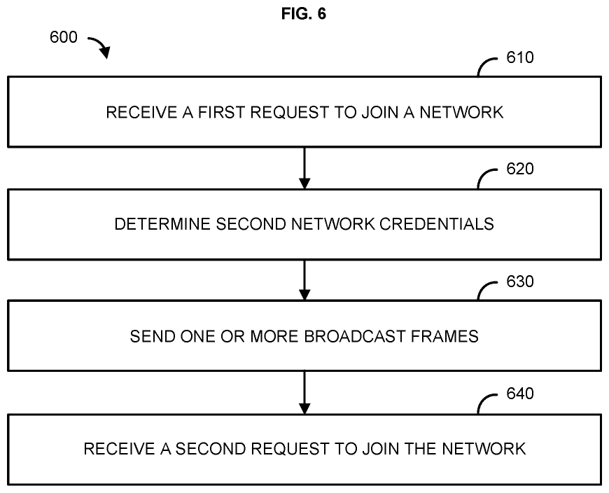

Turning now to FIG. 6, a flowchart of an example method 600 for network credential management is shown. The method 600 may be implemented using the network device 102. A network may be generated by a first computing device. The first computing device may be an access point, a router, a gateway device, a network hub, a repeater, a bridge, and/or the like. The network may be a wireless network, such as a WiFi network. To communicate with the network, client devices may be required to provide network credentials to the first computing device. The network credentials may include, for example, a network name and a network password. The network name may be an identifier for the network, such as an SSID. The network password may be a string of characters including letters, digits, and/or other symbols. A second computing device (e.g., a client device) may determine a public key and a private key associated with the public key. The second computing device may be a user device, a tablet, a laptop, a desktop, a mobile device, a set-top box, a sensor, a camera, an appliance, or a smart device, and/or the like. The second computing device may comprise one or more wireless interfaces, such as an 802.11 radio, a ZigBee radio, a Z-Wave radio, or a Bluetooth™ radio. Each of the one or more wireless interfaces may have an assigned Media Access Control (“MAC”) address. The public key and the private key may be associated with one or more MAC addresses of the one or more wireless interfaces. For example, the public key and/or the private key may identify one or more MAC addresses of the one or more wireless interfaces.

At step 610, the first computing device may receive a first request to communicate with the network. The first request may be sent by the second computing device along with the public key. The first request may comprise the network credentials. The first computing device may store the public key. For example, the first computing device may store the public key in a network routing table. The public key may be stored in the network routing table along with the network credentials. The first computing device may allow the second computing device to communicate with the network based on the first request. The first computing device may determine that the network credentials are valid. The first computing device may allow the second computing device to communicate with the network based on the network credentials being valid.

The second computing device may send the public key to the first computing device separate from the first request. For example, the second computing device may send the first request directed to a first communication port of the first computing device using a first wireless interface (e.g., an 802.11 radio), and the second computing device may send the public key directed to another communication port of the first computing device using a second wireless interface (e.g., Bluetooth™). The public key may identify the MAC address of the first wireless interface and the MAC address of the second wireless interface. The first computing device may determine that the public key was received from the client device based on the MAC address associated with the first request corresponding to the MAC address of the first wireless interface identified by the public key.

At step 620, the first computing device may determine an update to the network credentials. For example, the first computing device may receive an instruction that causes the first computing device to determine the update to the network credentials. The instruction may be received from a user device, such as a mobile device, a computing device, etc. For example, the first computing device may determine the update to the network credentials based on a network rule. The network rule may cause the first computing device to determine the update to the network credentials at a specific date and/or time (e.g., a date and/or time defined by the network rule) or after a specific duration of time has elapsed (e.g., a quantity of hours, days, months, etc., defined by the network rule). The updated network credentials may include, for example, a new network name (e.g., a new SSID) and/or a new network password.

The first computing device may determine which client device(s) listed in the network routing table has not sent a request to communicate with the network including the updated network credentials. For any such client device(s), the first computing device may determine whether the public key associated with the client device(s) has expired. For example, the first computing device may determine that the second computing device has not sent a request to communicate with the network including the updated network credentials. The first computing device may make this determination by comparing the updated network credentials to the network credentials stored in the network routing table with the public key associated with the second computing device. The first computing device may determine that the public key associated with the second computing device has not expired based on a time to live (“TTL”) element of the public key. The first computing device may encrypt the updated network credentials using the public key associated with the second computing device (e.g., based on determining that the TTL element is unexpired).

The first computing device may reestablish (e.g., rebroadcast) the network such that client devices may be required to provide the updated network credentials to the first computing device to communicate with the network. The first computing device may broadcast information identifying the network, such as a network name (e.g., SSID), by sending (e.g., emitting) one or more messages. The one or more messages may be network messages, broadcast frames, wireless network frames, Internet Protocol packets, beacon frames, a combination thereof, and/or the like. For example, the first computing device may send the one or more messages as one or more wireless network frames (e.g., 802.11 frames) via a wireless channel (e.g., an 802.11 channel). The encrypted network credentials may be sent to the second computing device via the one or more messages. For example, the encrypted network credentials may be sent to the second computing device via the one or more messages by appending the encrypted network credentials to one or more of the wireless network frames.

At step 630, the first computing device may send the one or more messages. For example, the first computing device may send the one or more messages as one or more of the wireless network frames appended with the encrypted network credentials using the same wireless channel. The first computing device may emit/broadcast the one or more wireless network frames as part of broadcasting the network. For example, the one or more wireless network frames may include the new network name as well as other identifying information for the network and/or the first computing device (e.g., channel identifier(s), MAC address(es), etc.). The one or more wireless network frames may be received by any computing device that is within a broadcast proximity of the first computing device. The first computing device may send the one or more wireless network frames until the TTL element expires and/or until the first computing device receives a request to communicate with the network from the second computing device including the updated network credentials. The second computing device may receive the one or more messages (e.g., using one of the one or more wireless interfaces). For example, the second computing device may receive the one or more messages as one or more of the wireless network frames appended with the encrypted network credentials. The second computing device may receive the one or more messages prior to the TTL element of the public key expiring. The second computing device may decrypt the encrypted network credentials using the private key. The second computing device may send a second request to communicate with the network to the first computing device. At step 640, the first computing device may receive the second request to communicate with the network from the second computing device. The second request may comprise the updated network credentials. The first computing device may allow the second computing device to communicate with the network based on the second request. The first computing device may determine that the updated network credentials are valid. The first computing device may allow the second computing device to communicate with the network based on the updated network credentials being valid. The first computing device may receive at least one communication from the second computing device via the network. For example, the at least one communication may be received by the first computing device after the first computing device determines that the updated network credentials received from the second computing device are valid and allows the second computing device to communicate with the network.

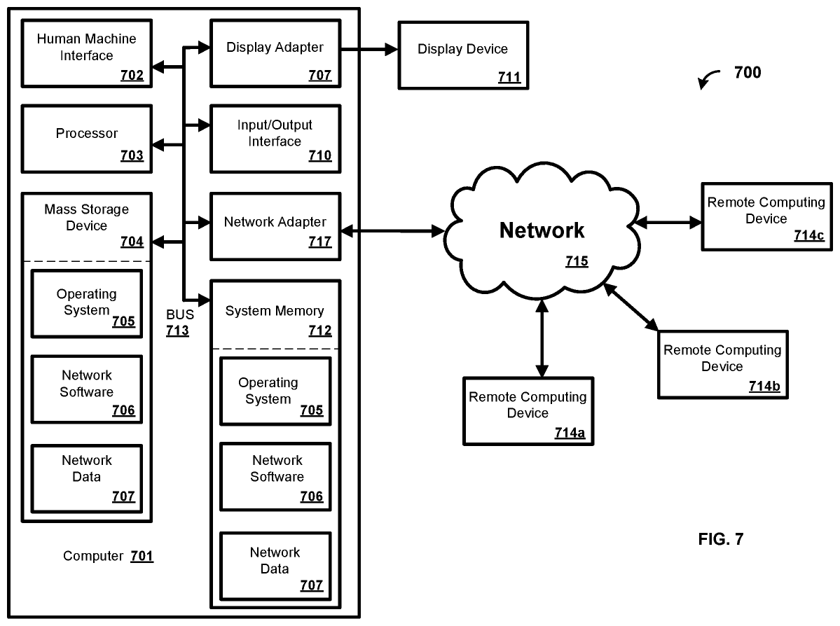

FIG. 7 is a block diagram illustrating an exemplary operating environment/system for performing the methods described herein. In an exemplary example, the methods and systems of the present description can be implemented on a computer 701 as illustrated in FIG. 7 and described below. By way of example, each of the devices of FIG. 1 may be a computer 701 as illustrated in FIG. 7. Similarly, the methods and systems described can utilize one or more computing devices to perform one or more functions in one or more locations. This exemplary operating environment/system is only an example of an operating environment/system and is not intended to suggest any limitation as to the scope of use or functionality of the operating environment/system architecture. Neither should the operating environment/system be interpreted as having any dependency or requirement relating to any one or combination of components illustrated in the exemplary operating environment/system.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and/or the like.

The processing of the described methods and systems can be performed by software components. The described systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The described methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods described herein can be implemented via a general-purpose computing device in the form of a computer 701. The components of the computer 701 can comprise, but are not limited to, one or more processors 703, a system memory 712, and a system bus 713 that couples various system components including the processor 703 to the system memory 712. In the case of multiple processors 703, the system can utilize parallel computing.

The system bus 713 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 713, and all buses specified in this description can also be implemented over a wired or wireless network connection and each of the subsystems, including the processor 703, a mass storage device 704, an operating system 705, network software 706, network data 707, a network adapter 708, system memory 712, an Input/Output Interface 710, a display adapter 709, a display device 711, and a human machine interface 702, can be contained within one or more remote computing devices 714a,b,c at physically separate locations, connected through buses of this form, in effect implementing a fully distributed system.

The computer 701 typically includes a variety of computer readable media.

Exemplary readable media can be any available media that is accessible by the computer 701 and includes, for example and not meant to be limiting, both volatile and non-volatile media, removable and non-removable media. The system memory 712 includes computer readable media in the form of volatile memory, such as random access memory (RAM), and/or non-volatile memory, such as read only memory (ROM). The system memory 712 typically contains data, such as network data 707, and/or program modules, such as operating system 705 and network software 706, that are immediately accessible to and/or are presently operated on by the processor 703.

For example, the computer 701 can also comprise other removable/non-removable, volatile/non-volatile computer storage media. By way of example, FIG. 7 illustrates a mass storage device 704 which can provide non-volatile storage of computer code, computer readable instructions, data structures, program modules, and other data for the computer 701. For example and not meant to be limiting, a mass storage device 704 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 704, including by way of example, an operating system 705 and network software 706 (e.g., to encrypt/decrypt network credentials, generate a network, send/receive data to/from an access point, etc.). Each of the operating system 705 and network software 706 (or some combination thereof) can comprise elements of the programming and the network software 706. The network data 707 (e.g., public key(s), private key(s), routing table(s), network credentials, etc.) can also be stored on the mass storage device 704. The network data 707 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

For example, the user can enter commands and information into the computer 701 via an input device (not shown). Examples of such input devices comprise, but are not limited to, a keyboard, pointing device (e.g., a “mouse”), a microphone, a joystick, a scanner, tactile input devices, such as gloves, and other body coverings, and the like These and other input devices can be connected to the processor 703 via a human machine interface 702 that is coupled to the system bus 713, but can be connected by other interface and bus structures, such as a parallel port, game port, an IEEE 1394 Port (also known as a Firewire port), a serial port, or a universal serial bus (USB).

In yet another example, a display device 711 can also be connected to the system bus 713 via an interface, such as a display adapter 709. It is contemplated that the computer 701 can have more than one display adapter 709 and the computer 701 can have more than one display device 711. For example, a display device can be a monitor, an LCD (Liquid Crystal Display), or a projector. In addition to the display device 711, other output peripheral devices can comprise components, such as speakers (not shown) and a printer (not shown) which can be connected to the computer 701 via Input/Output Interface 710. Any step and/or result of the methods can be output in any form to an output device. Such output can be any form of visual representation, including, but not limited to, textual, graphical, animation, audio, tactile, and the like. The display 711 and computer 701 can be part of one device, or separate devices.

The computer 701 can operate in a networked environment/system using logical connections to one or more remote computing devices 714a,b,c. By way of example, a remote computing device can be a personal computer, portable computer, smartphone, a server, a router, a network computer, a peer device or other common network node, and so on. Logical connections between the computer 701 and a remote computing device 714a,b,c can be made via a network 715, such as a local area network (LAN) and/or a general wide area network (WAN). Such network connections can be through a network adapter 708. A network adapter 708 can be implemented in both wired and wireless environments/systems. Such networking environments/systems are conventional and commonplace in dwellings, offices, enterprise-wide computer networks, intranets, and the Internet.

For purposes of illustration, application programs and other executable program components, such as the operating system 705 are illustrated herein as discrete blocks, although it is recognized that such programs and components reside at various times in different storage components of the computing device 701, and are executed by the data processor(s) of the computer. An implementation of network software 706 can be stored on or transmitted across some form of computer readable media. Any of the described methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information, such as computer readable instructions, data structures, program modules, or other data. Exemplary computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

While the methods and systems have been described in connection with specific examples, it is not intended that the scope be limited to the particular embodiments and/or examples set forth, as the embodiments and/or examples herein are intended in all respects to be illustrative rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments and/or examples described in the specification.

It will be apparent to those skilled in the art that various modifications and variations can be made without departing from the scope or spirit. Other embodiments and/or examples will be apparent to those skilled in the art from consideration of the specification and practice described herein. It is intended that the specification and examples be considered as exemplary only, with a true scope and spirit being indicated by the following claims.

What is claimed is:

1. A method comprising:
receiving, by a first computing device, from a second computing device:
a first request, to communicate via a network, that comprises network credentials associated with the network, and
a public key associated with the second computing device;
determining an update to the network credentials;
sending, based on the update to the network credentials, one or more messages comprising updated network credentials, wherein the updated network credentials are encrypted using the public key;
receiving, from the second computing device, a second request, to communicate via the network, that comprises the updated network credentials; and
allowing, based on the second request, the second computing device to communicate via the network.

2. The method of claim 1, wherein the public key comprises a time to live (“TTL”) element, and wherein sending the one or more messages comprising the updated network credentials is based on:
determining that the TTL element of the public key is unexpired.

3. The method of claim 1, wherein sending the one or more messages comprising the updated network credentials comprises at least one of:
sending, until a time to live (“TTL”) element associated with the public key expires, the one or more messages comprising the updated network credentials; or
sending, until the second request to communicate via the network is received, the one or more messages comprising the updated network credentials.

4. The method of claim 1, wherein the one or more messages comprise at least one of a network message, a broadcast frame, an Internet Protocol packet, or a beacon frame.

5. The method of claim 1, wherein determining the update to the network credentials is based on at least one of:
receiving, from a user device, an instruction associated with the network;
receiving, from an administrative device, an instruction associated with the network; or
determining, based on a network rule, the update to the network credentials.

6. The method of claim 1, further comprising receiving, from the second computing device via the network, at least one communication.

7. The method of claim 1, further comprising:
receiving, by the second computing device, the one or more messages;
decrypting, by the second computing device, the updated network credentials using a private key associated with the public key; and
sending, by the second computing device to the first computing device, the second request to communicate via the network.

8. The method of claim 1, wherein the one or more messages comprise a plurality of messages, and wherein each message of the plurality of messages:
is associated with one computing device of a plurality of computing devices, and
comprises updated network credentials encrypted using a public key corresponding to the one computing device.

9. A method comprising:
determining by a second computing device:
a public key, and
a private key associated with the public key;
sending to a first computing device:
the public key, and
a first request, to communicate via a network, that comprises network credentials associated with the network;
receiving, from the first computing device, one or more messages comprising updated network credentials, wherein the updated network credentials are encrypted using the public key;
decrypting the updated network credentials using the private key; and
sending, to the first computing device, a second request, to communicate via the network, that comprises the updated network credentials.

10. The method of claim 9, wherein the first computing device comprises at least one of a gateway, a router, a network hub, a repeater, a bridge, or an access point, and wherein the second computing device comprises at least one of a user device, a tablet, a laptop, a desktop, a mobile device, a set-top box, a sensor, a camera, an appliance, or a smart device.

11. The method of claim 9, wherein the public key comprises a time to live (“TTL”) element, and wherein receiving the one or more messages comprising the updated network credentials comprises receiving, prior to an expiration of the TTL element, the updated network credentials.

12. The method of claim 9, wherein the one or more messages comprise at least one of a network message, a broadcast frame, an Internet Protocol packet, or a beacon frame.

13. The method of claim 9, wherein the public key comprises a time to live (“TTL”) element, and the method further comprises at least one of:
sending, by the first computing device, the one or more messages until the TTL element expires, or
sending, by the first computing device, the one or more messages until the second request to communicate via the network is received.

14. The method of claim 9, further comprising sending, to the first computing device via the network, at least one communication.

15. The method of claim 9, further comprising:
receiving, by the first computing device, from the second computing device:
the first request to communicate via the network, and
the public key;
sending, by the first computing device, the one or more messages; and
receiving, by the first computing device from the second computing device, the second request to communicate via the network.

16. A system comprising:
a first computing device configured to:
receive, from a second computing device, a first request, to communicate via a network, that comprises network credentials associated with the network;
receive a public key associated with the second computing device;
determine an update to the network credentials;
send, based on the update to the network credentials, one or more messages comprising updated network credentials, wherein the updated network credentials are encrypted using the public key;
receive a second request, to communicate via the network, that comprises the updated network credentials; and
allow, based on the second request, the second computing device to communicate via the network; and
the second computing device configured to: after the second request, communicate via the network.

17. The system of claim 16, wherein the public key comprises a time to live (“TTL”) element, and wherein the first computing device is further configured to send the one or more messages comprising the updated network credentials based on a determination that the TTL element of the public key is unexpired.

18. The system of claim 16, wherein the one or more messages comprise at least one of a network message, a broadcast frame, an Internet Protocol packet, or a beacon frame.

19. The system of claim 16, wherein the first computing device is further configured to determine the update to the network credentials based on at least one of:
receiving, by the first computing device from a user device, an instruction associated with the network;
receiving, by the first computing device from an administrative device, an instruction associated with the network; or
determining, by the first computing device based on a network rule, the update to the network credentials.

20. The system of claim 16, wherein the first computing device is further configured to receive, from the second computing device via the network, at least one communication.
